(19) United States
(12) Patent Application Publication
(10) Pub. No.: US 2009/0119408 A1
(43) Pub. Date: May 7, 2009

(54) METHOD FOR MANAGING EXECUTION BY A SERVER OF AN APPLICATION PROVIDING AT LEAST ONE INTERACTIVE MULTIMEDIA SERVICE TO AT LEAST ONE TERMINAL, CORRESPONDING COMPUTER PROGRAM PRODUCT AND SERVER

(75) Inventors: Vincent Teze, Landeda (FR); Claude Daloz, Lannion (FR); Francois Toutain, Louannec (FR)

Correspondence Address: WESTMAN CHAMPLIN & KELLY, P.A., SUITE 1400, 900 SECOND AVENUE SOUTH, MINNEAPOLIS, MN, 55402, US

(73) Assignee: France Telecom, Paris (FR)

(21) Appl. No.: 11/917,695

(22) PCT Filed: Jun. 7, 2006
(86) PCT No.: PCT/EP2006/062982

§ 371 Date: Jul. 21, 2008

(30) Foreign Application Priority Data
Jun. 17, 2005 (FR) 05/06196

(51) Int. Cl. G06F 15/16

(52) U.S. Cl. 709/231

(57) ABSTRACT

A method is provided for managing execution by a server of an application providing at least one interactive multimedia service to at least one terminal connected to the server via a communication network. The method includes the following steps performed by the server: converting outputs of the application in the form of at least one first multimedia stream capable of being presented by the at least one terminal; and transmitting the at least one first multimedia stream to the at least one terminal, via a communication set up between the server and the at least one terminal. In one particular example, the method further includes the following steps performed by the server: receiving inputs of the application, which the at least one terminal transmits to the server via the communication; and converting the application inputs into commands for monitoring the application.

### CROSS-REFERENCE TO RELATED APPLICATIONS

This Application is a Section 371 National Stage Application of International Application No. PCT/EP2006/062982, filed Jun. 7, 2006 and published as WO 2006/134055 on Dec. 21, 2006, not in English.

### FIELD OF THE DISCLOSURE

The field of the disclosure is that of audio and/or video communications that take place in a communications network of a switched telephony network, integrated services digital network, packet-switched network or wireless telephony network type or any type of network enabling audio and/or video communications.

More specifically, the disclosure relates to a technique enabling terminals capable of receiving multimedia streams (containing audio and/or video type information) to access interactive multimedia services offered by applications (also called application software) that are executed on remote servers. Each server may be a unique machine or it may be distributed over several machines.

The disclosure can be applied especially but not exclusively in the case of a server providing at least one interactive multimedia service with videophones.

### BACKGROUND OF THE DISCLOSURE

Today, only large-capacity terminals, such as certain mobile phones, can execute an application software program (for example a downloaded Java game) on their own.

For terminals not having such high capacity, the application software may be executed on a server (generally dedicated) provided that the terminals have minimum capacity for the installation therein of a thin client (hardware or software) enabling interaction with the server.

A Web navigator is an example of a thin client integrated by a terminal. It enables the terminal especially to login to an http server in using the http protocol (hypertext transfer protocol) to transfer and display web pages in the HTML (“HyperText Markup Language”) or in hypertext. It is important to note that, with regard to the outputs from the application executed by the server, the server does not send the terminal a multimedia stream (web pages) which the terminal can present directly without prior processing. The server transmits information (HTML markers) that the Web navigator of the terminal must process in order to generate a multimedia stream. Similarly, with regard to the inputs of the application executed by the server, the terminal does not send the inputs from the user (made for example via a keyboard or a joystick) directly to the server without preliminary processing. The Web navigator of the terminal must process these entries to convert them into http requests which are then sent to the server.

Apart from the Web navigator, there are techniques for personal computers (PCs) enabling the use of a machine remotely. For example, there are the prior art software programs “GotoMyPC” (registered mark) by Citrix Systems or again “PcAnyWhere” (registered mark) by Symantec which are software programs for taking control over a PC at a distance. With these techniques, the applications get executed on a distant machine, the terminal (PC) being used only as an input and display peripheral. But here again, the terminal (PC) must have minimum capacity for the execution of a thin client.

Now, there are many limited-capacity terminals (present-day videophones for example) that do not have this minimum capacity for the execution of a thin client, and which therefore cannot access interactive multimedia services offered by application software getting executed on distant servers.

In other words, many present-day interactive services are inaccessible from basic terminals because they require that the terminals accessing them should be equipped with a particular (software or hardware) client.

Furthermore, the input peripherals on these limited-capacity terminals are often very limited (for example DTMF only on the videophone) and their video output can support only video streams in very specific formats.

### SUMMARY

An aspect of the disclosure relates to a method for managing the execution by a server of an application offering at least one interactive multimedia service to at least one terminal connected to the server via a communications network. The method comprises the following steps performed by the server:
converting outputs of the application in the form of at least one first multimedia stream capable of being presented by said at least one terminal; and
transmitting said at least one first multimedia stream to said at least one terminal, via a communication set up between the server and said at least one terminal.

The general principle of an exemplary embodiment of the invention therefore consists of the performance, in the server, of a conversion at the outputs of the application so that, after conversion, they are compatible with the terminals without these terminals executing a particular thin client (Web navigator or the like). In other words, it is a server that adapts the service, and more specifically the outputs of the application to the most basic terminals, which are required only to be capable of receiving multimedia streams (for example an audio/video stream for a videophone).

Thus, the embodiment enables one or more basic terminals to individually or severally access a multitude of services being executed on a distant server (which itself is executed by one or more machines).

It is enough that these basic terminals should be capable of presenting the output of the application corresponding to the service, or even (in the advantageous embodiment described here below) of driving this application.

In one advantageous embodiment, the method furthermore comprises the following steps performed by the server:
receiving inputs of the application which said at least one terminal transmits to the server, via said communication; and
converting inputs of the application into commands used to drive the application.

In this case, the terminal or terminals can drive the application despite the fact that they execute no particular thin client (Web navigator or the like). Again, it is the server that adapts the service to the most basic terminals which are required only to be capable of sending the inputs of the application (for example DTMF signals generated by the user pressing a keyboard, for example for a videophone).

Advantageously, the server receives the inputs of the application coming from said at least one terminal in at least one second multimedia stream and/or in at least one signaling channel associated with said communication.

Advantageously, the step of conversion of the outputs of the application in the form of at least one first multimedia stream is based on a technique belonging to the group comprising the following (non-exhaustive list):
the capture, at determined instants, of a screen image resulting from the execution of the application, and then the conversion of the sequence of captured images thus obtained into at least one video stream, in real time;
the performance, by the application, of a direct display in memory, then the conversion of the direct display in memory into at least one video stream.

This list, specific to video, is not exhaustive.

In one particular embodiment, the server comprises a signaling server and a processing server, and the processing server performs the step of conversion of the outputs of the application and the step of transmission of said at least one first multimedia stream.

As explained in detail here below, this subdivision into signaling server and processing server is valid in the case of an embodiment with SIP-servlet.

One or more embodiments of the disclosure can be applied equally well when the server is executed on one or more machines dedicated to the supply of said at least one interactive multimedia service and when the server is executed on one or more machines not dedicated to the supply of said at least one interactive multimedia service.

In a particular application, said at least one terminal is a basic terminal that integrates no particular processing capacity.

The terminal is for example a videophone. It is clear that, more generally, one or more embodiments of the disclosure can be applied to any type of terminal capable of receiving and presenting a multimedia stream coming from the server and, if the terminal has to drive the application, of sending the inputs of the application in a crude way (i.e. without processing) to the server.

In a first particular embodiment, the server is seen by said at least one terminal as a call termination point.

In a second particular embodiment, the server gets interposed transparently in a position to cut off a communication between said at least one terminal and another terminal.

The disclosure also relates to a computer program product downloadable from a communications network and/or recorded on a computer-readable carrier and/or executable by a processor, this computer program product comprising program code instructions for the execution of the steps of the above-mentioned method, when said program is executed on a computer.

The disclosure also relates to a server of the type enabling the execution of an application providing at least one interactive multimedia service to at least one terminal connected to the server via a communications network. The server comprises:
means of conversion of outputs of the application in the form of at least one first multimedia stream capable of being presented by said at least one terminal; and
means of transmission of said at least one first multimedia stream to said at least one terminal via a communication set up between the server and said at least one terminal.

### BRIEF DESCRIPTION OF THE DRAWINGS

Other features and advantages shall appear from the following description of the preferred embodiment, given by way of an indicative and non-restrictive example, and from the appended drawings, of which:

FIG. 1 presents an example of a system in which it is possible to implement the method according to an exemplary embodiment of the invention, comprising a server according to an embodiment of the invention;

FIG. 2 is a flow chart of a particular embodiment of the method;

FIG. 3 is a simplified representation of the service rendered to a terminal by a server;

FIG. 4 is a functional block diagram of particular embodiment of the server, comprising a signaling server and a processing server;

FIGS. 5, 6 and 7 each present a distinct example of exchange kinematics between a terminal and the signaling and processing servers appearing in FIG. 4; and

FIG. 8 presents the structure of the machine executed in a server.

### DETAILED DESCRIPTION OF ILLUSTRATIVE EMBODIMENTS

The disclosure therefore relates to a method of management of the execution by a server of an application offering at least one interactive multimedia service to at least one terminal connected to the server via a communications network.

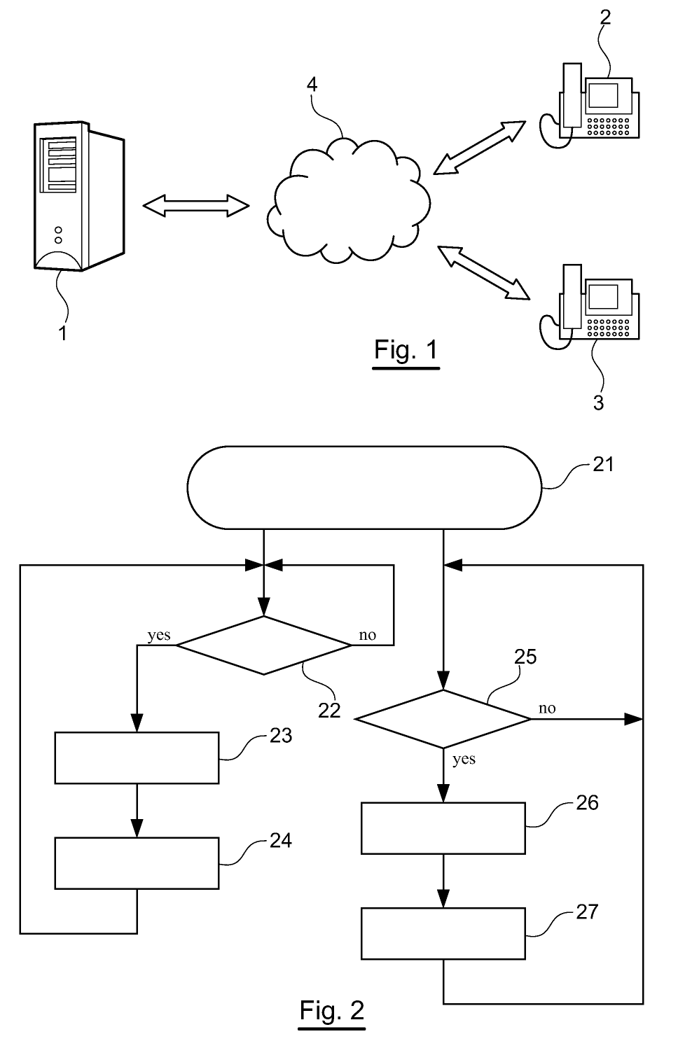

Thus, in the example illustrated in FIG. 1, the server 1 provides an interactive multimedia service to one of the terminals 2, 3 (or to both of them), the terminals being, for example, videophones. To this end, a communication is set up, via a communications network for, between the server 1 and the terminals 2, 3.

In this example, the server 1 is executed on a single machine. The disclosure can also be applied to the case where the server is executed on several machines.

Referring now to FIG. 2, we present a particular embodiment of the method. It is assumed for example that a terminal (for example the one referenced 2 in FIG. 1) wishes to obtain the benefit of a multimedia service offered by the server (referenced 1 in FIG. 1).

In a step 21, the server executes an application aimed at offering an interactive multimedia service to the terminal.

In a step 22, the server verifies whether the application has generated an output. In the event of positive verification at the step 22, the server performance a step 23 of conversion of this output of the application into at least one first multimedia stream capable of being presented directly, without preliminary processing, by the terminal. Then, in a step 24, the server transmits this first stream or these first streams to the terminal via a communication set up between the server and the terminal. Finally, the server returns to the step 22. In the event of negative verification at the step 22, the server returns directly to the step 22.

At the same time, in a step 25, the server checks to see whether the terminal has transmitted an input of the application to it, directly and without preliminary processing. In the event of positive verification at the step 25, the server receives the input transmitted by the terminal, in a step 26. Then, in a step 27, the server converts this input (for example a DTMF signal) into one or more commands enabling the application to be driven. Finally, the server returns to the step 22. In the event of negative verification of the step 25, the server returns directly to the step 25.

Thus, in this particular embodiment, the method enables the setting up of a mechanism that manages the execution of an application on a distant server but has its output and inputs situated on (at least) one terminal, even if it is basic. The criteria for this mechanism are the following:
a given session gives rise to the execution of an application on a server of interactive services (it may be a dedicated server or else an advanced terminal with a private individual);
the outputs of the application (video display, audio display etc) are sent in the form of media streams to one or more terminals connected according to their capacities; and
the inputs entered by the terminal or terminals may be sent to the application and enable it to be driven from the terminal having generated the inputs.

The inputs may be of various types: DTMF (“Dual Tone MultiFrequency”), voice, video with shape or gestural recognition in a video stream (the recognition can then be done on the machine receiving the stream), or the like.

Thus, the method enables the performance of the interactive application software that can be used and driven from any limited-capacity terminal whatsoever (a terminal compatible with the type of application software that is to be accessed). This application software can be a game, and interface for configuration of its services or any other type of application software with potential interactions for the user. Several terminals may be in communication with the application software (multi-player games, document-sharing, presentations etc).

It must be noted that, in one alternative embodiment, the method offers the possibility of accessing an application software without driving it from the terminal. In this case, no input of the application is entered at the terminal and the method is limited to the steps 21 to 24 of FIG. 2.

This variant can be applied in the case of a hotline for a software program, where the professional person is capable of seeing and guiding the client remotely on his software program. The client's terminal here plays the role of the services server and the client's software is the application executed by this server. In this case, the client's software (or module installed on his machine) is used to capture the output of the client's software and convert it into a media stream accepted by the limited-capacity terminal of the hotline. It can then be imagined that it is the limited-capacity terminal of the hotline that initiates the call or else that it is the client's terminal.

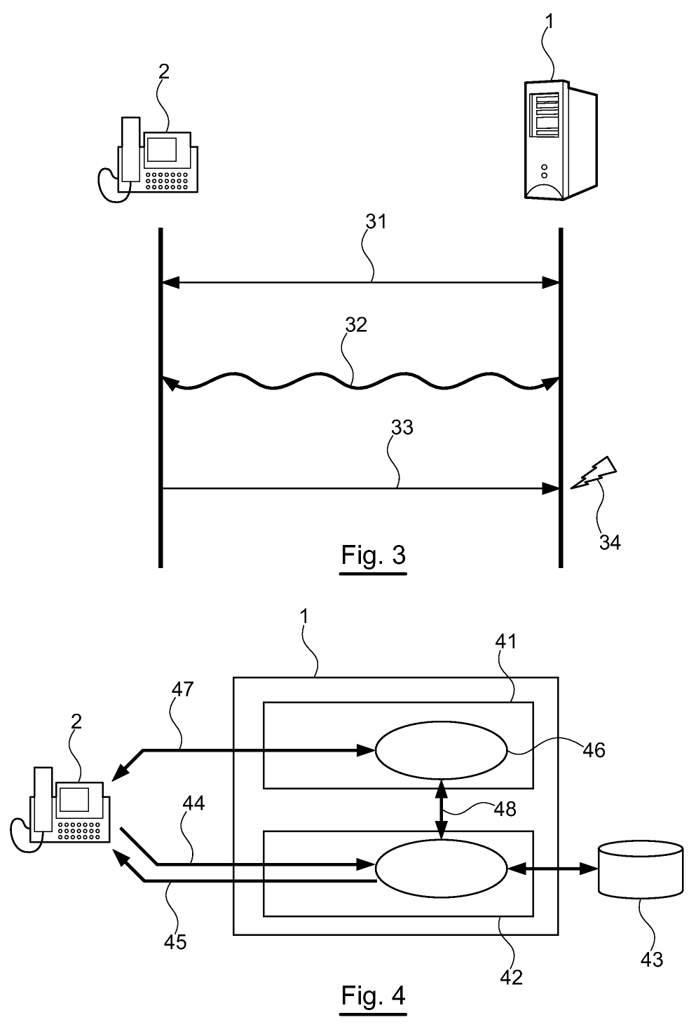

In any case (Voice over IP (VoIP), RTC, mobile, etc.), the service rendered to a terminal 2 by a server 1 can be represented by the drawing of FIG. 3.

The interactive services server can be seen as a terminal (the case of a service portal which will be called directly, by simply dialing a number (or an alias) as in the case of setting up a classic telephone communication).

In one alternative embodiment, the server can get interposed transparently in a position to cut off a call set up with a correspondent (active services in communication). In this case of operation in which the application software server is placed in a position to cut off a communication, it puts itself effectively in a position to cut-off only if necessary (for example if the caller or called party is not a subscriber to the specific service, the call takes place normally) or at the request of one of the users.

Among the exchanges between the terminal 2 and the server 1, it is possible to distinguish the exchanges (reference 31) pertaining to the setting up of the call, the exchanges (referenced 32) pertaining to the multimedia streams and the exchanges (referenced 33) pertaining to the inputs (commands) transmitted to the server by the terminal in order to activate inaction (symbolized by the arrow referenced 34) in the application.

The inputs (commands) 33 transmitted to the server by the terminal can be either messages in the signaling of the communication (the case of the DTMF in the INFO in SIP messages) or media streams which are interpreted by the server as a commands (as for example in voice recognition).

Referring to FIG. 4, a particular embodiment of the server 1 is now presented in a particular mode of implementation, in voice-over-IP with SIP signaling protocol.

In this case, the service can be rendered for example by means of two apparatuses: a signaling server (41) traditionally called AS for Application Server in the SIP world) and a processing server (or PS) 42. In other words, the server 1 discussed here above itself comprises the signaling server 41 and the processing server 42. To this can be added all the elements that may possibly be necessary to provide the processing (database 43, data or content servers etc).

A communication (here, the example is given with only one participant, namely the terminal 2) takes place in two steps:
the caller 2 dials the number of the service, the signaling server 41, determines the available processing server 42 corresponding to the requested service and sees to it that the media streams 44 of the caller 2 are sent to the processing server 42 and that the media streams 45 of the processing server 42 are sent to the caller 2;
the caller 2 can interact with the processing server 42 by means of the input peripheral of his terminal, the commands being sent in the form of media streams or in the signaling (and in this case relayed by the SIP-servlet 46) and interpreted by the processing server 42.

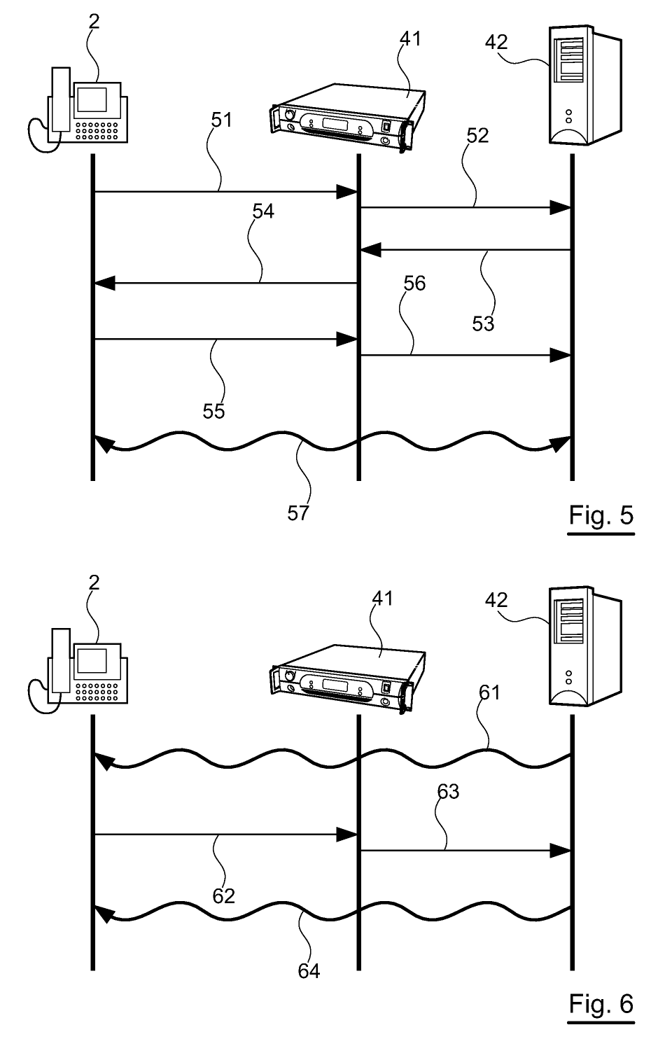

The role of the signaling server 41 is now presented with reference to the examples of exchange kinematics of FIGS. 5, 6 and 7.

In the kinematics of a call set-up operation (illustrated in FIG. 5), the call set-up operation proceeds normally, except that the signaling server 41 intercepts the communication set-up request in order to set the media stream exchanges between the caller 2 and the processing server 42. In one particular embodiment, this interception is done by a SIP-servlet 46, written in Java. The SIP-servlet 46 asks to view a passage of certain request messages of the SIP (Session Initiation Protocol). When an SIP message “INVITE 51 is received via a signaling channel 47, the servlet 46 consults the payload of the message which is a description in the SDP (Session Description Protocol) format of the different streams which should be involved in the communication (i.e. the streams that the caller 2 wishes to receive in the communication session). The server 46 gives the processing server 42 the addresses 52 associated with each stream of the caller designed to interact with the processing server 42. In return, the processing server 42 gives the servlet 46 the addresses 53 to the corresponding to the streams of the processing server 42 associated with the caller. This is done by means of a programming interface (or API for Application Programming Interface) 48 which may be a proprietary interface or a standard interface (for example SIP). The Servlet 46 simulates a called terminal in accepting the communication in returning an SIP message “200OK” 54 to the caller. This “200OK” message 54 contains the addresses and types of streams associated with the processing server 42. The servlet 46 also intercepts the SIP acknowledgement message “ACK” 55 from the caller 2 following the SIP message “200OK” 54 in order to send the processing server 42 a request 56 for launching the application software. After the call has been set up, the processing server 42 and the caller 2 send each other streams 57.

For the driving of the application software by the caller, several prior art techniques may be envisaged to convey the caller's entries in the communication session: these techniques include voice, video stream, gestural recognition, in-band DTMF or out-of-band DTMF etc. It is possible that the servlet 46 will be responsible for reception of these inputs (activation operations) in which case it transmits them to the processing server 42.

In the kinematics illustrated in FIG. 6, relative to the driving of the application software by the caller, it is assumed by way of an example that the triggering operations (entries) are conveyed in out-of-band DTMF form. It is also assumed that the processing server 42 sends out media streams 61, sent to the caller 2. The caller 2 drives the application software by pressing, for example, a key on the keyboard of his terminal. In the example, this produces a message “INFO (DTMF)” 62 of the SIP protocol which conveys the DTMF digit associated with this key. The signaling server 41 intercepts this message “INFO (DTMF)” 62 and transmits an activation request 63 to the processing server 42. The processing server 42 acts on this activation request according to the application software in progress. In this example, the activation leads to an updating of the media streams 64 sent to the caller 2. Certain application software programs may continually update these media streams without action by the caller, depending on the nature of the application.

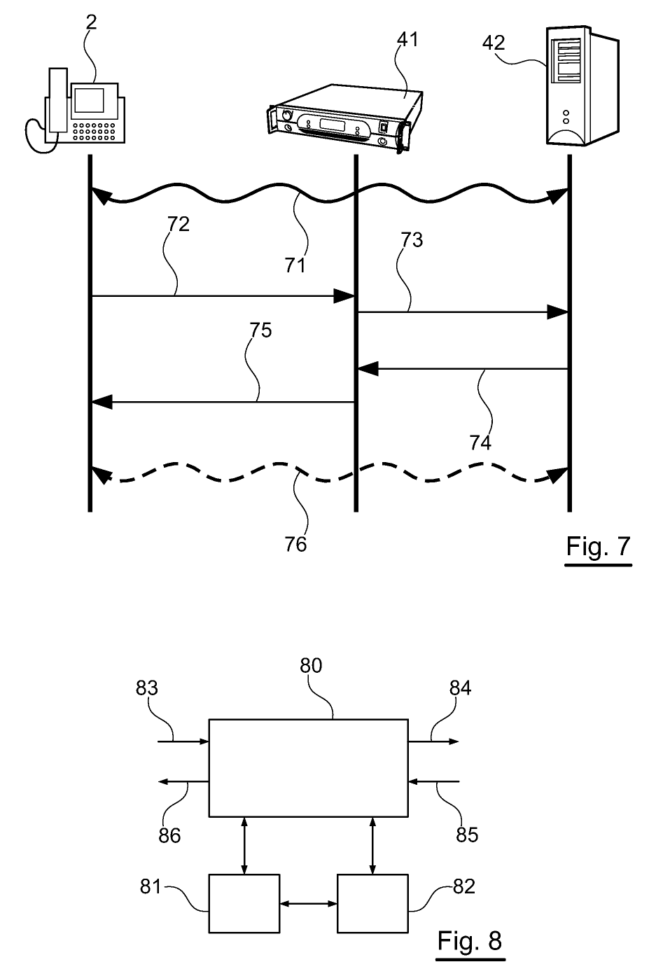

The kinematics illustrated in FIG. 7 relate to the termination of the communication by the caller. It is assumed that the processing server 42 and the caller 2 are sending each other streams 71. The signaling server 41 intercepts the end of call SIP message “BYE”, 72 sent by the caller and transmits a “stop service” request 73 to the processing server 42. The processing server 42 responds with an acknowledgement message 74 and the signaling server 41 sends an SIP message “200OK” 75 to the caller in order to terminate the call in turn. The caller and the processing server 42 stop all operations of sending media streams between themselves (as symbolized by the dashes referenced 76).

The role of the processing server 42 is now presented.

This processing server 42 acts like an end of call terminal as regards the media streams. It explains the above-mentioned API 48 enabling the servlet 46, included in the signaling server 41, to initialize the input/output addresses and, as the case may be, to drive the application software program of the processing server 42 if the entries of the caller are received by the servlet.

It is capable of converting the outputs of the application software program into numerous data formats conveyed by the media streams via many audio and/or video codecs. It implements the stream transport protocols such as RTP (real-time transport protocol) or RTCP (real-time transport control protocol).

A mechanism for making a declaration with the servlet 46 may be managed by the processing server 42 to enable a unit to declare that it is available to take the call.

The processing server 42 may or may not have outputs on the application software execution machine.

The service delivered by the processing server 42 may be of greater or lesser complexity and may be a menu to other services which will then be executed by the processing server 42 or simply relayed by it or, again, given directly by a new server after transfer.

The processing server 42 can take several forms, for example:
a module external to the application enabling the capturing of a part of the screen (output of the application) and its conversion into RTP media streams toward the terminals. This module also works like a robot application that can be used for example to take control of the cursor (movements and generation of clicks) depending on incoming information (inputs of the application) from the driving terminals;
a model integrated into the application, enabling the retrieval of a display (buffer) memory (for example, but this is valid for all other types of outputs of the application) to convert it into RTP media streams. This module then retrieves the inputs coming from the terminals and may act directly on the elements of the application.

In other embodiments, the interactive services server is itself a communication terminating element for the streams as well as the signaling. It will also be an element in the communications network or else a correspondent in the same way as the terminal requesting the service (in the case of a “peer-to-peer” network for example).

FIG. 8 finally presents a structure of a machine executing a server, the server itself executing an application software offering at least one interactive multimedia service. The machine comprises a memory 81 and a processing unit 80 equipped with a microprocessor driven by a computer program (or application) 82.

The processing unit 80 receives outputs from the application program 83 which the microprocessor processes, according to the instructions of the program 82, to convert them into one or more multimedia streams 84 transmitted to one or more terminals so that these terminals present them directly, without preliminary processing.

The processing unit 80 furthermore receives inputs from the application software program 85, transmitted by one or more terminals, which the microprocessor processes according to the instructions of the program 82 to convert them into one or more commands 86 enabling the applications program to be driven.

It is clear that many other embodiments can be envisaged. In particular, it can be planned that the server will be executed on several machines.

One example of the present disclosure provides a technique for the management of the execution by a server of an application offering at least one interactive multimedia service to at least one terminal, this technique being capable of being implemented with limited-capacity terminals without its being necessary for these terminals to execute a thin client.

At least one example provides a technique of this kind enabling the terminal to access an application (application software) in driving it.

At least one alternative example provides a technique of this kind enabling the terminal to access an application (application software) without driving it.

At least one example provides a technique of this kind that is simple to implement and costs little.

At least one example provides a technique of this kind that requires no modification of existing low-capacity terminals, such as the videophone for example.

Although the present disclosure has been described with reference to one or more examples, workers skilled in the art will recognize that changes may be made in form and detail without departing from the scope of the disclosure and/or the appended claims.

1. Method for managing execution by a server of an application offering at least one interactive multimedia service to at least one terminal connected to the server via a communications network, wherein the method comprises the following steps performed by the server:
converting outputs of the application in the form of at least one first multimedia stream capable of being presented by said at least one terminal; and
transmitting said at least one first multimedia stream to said at least one terminal, via a communication set up between the server and said at least one terminal.

2. Method according to claim 1, further comprising the following steps performed by the server:
receiving inputs of the application, which said at least one terminal transmits to the server, via said communication; and
converting the inputs of the application into commands used to drive the application.

3. Method according to claim 2, wherein the server receives the inputs of the application coming from said at least one terminal in at least one second multimedia stream and/or in at least one signaling channel associated with said communication.

4. Method according to claim 1, wherein converting the outputs of the application in the form of at least one first multimedia stream is based on a technique belonging to the group comprising:
capturing, at determined instants, a screen image resulting from the execution of the application, and then converting the sequence of captured images thus obtained into at least one video stream, in real time; and
performing, by the application, a direct display in memory, then converting the direct display in memory into at least one video stream.

5. Method according to claim 1, wherein the server comprises a signaling server and a processing server, and the processing server performs the step of converting the outputs of the application and the step transmitting said at least one first multimedia stream.

6. Method according to claim 1, wherein said at least one terminal comprises a basic terminal integrating no particular processing capacity.

7. Method according to claim 1, wherein the server is seen by said at least one terminal as a call termination point.

8. Method according to claim 1, wherein the server gets interposed transparently in a position to cut off a communication between said at least one terminal and another terminal.

9. Computer program product recorded on a computer-readable carrier, this computer program product comprising program code instructions for executing the following method, when said program is executed on a computer:
managing execution by a server of an application offering at least one interactive multimedia service to at least one terminal connected to the server via a communications network, wherein the managing comprises the following steps performed by the server:
converting outputs of the application in the form of at least one first multimedia stream capable of being presented by said at least one terminal; and
transmitting said at least one first multimedia stream to said at least one terminal, via a communication set up between the server and said at least one terminal.

10. Server of the type enabling the execution of an application providing at least one interactive multimedia service to at least one terminal connected to the server via a communications network, wherein the server comprises:
means for converting outputs of the application in the form of at least one first multimedia stream capable of being presented by said at least one terminal; and
means for transmitting said at least one first multimedia stream to said at least one terminal via a communication set up between the server and said at least one terminal.

11. Server according to claim 10, wherein the server furthermore comprises:
means for receiving inputs of the application that said at least one terminal transmits to the server via said communication; and
means for converting inputs of the application enabling the application to be driven.
